(19) United States
(12) Patent Application Publication
(10) Pub. No.: US 2008/0196008 A1
(43) Pub. Date: Aug. 14, 2008

(54) Method of Operating a Computing Device

(75) Inventors: Joe Branton, New South Wales (AU); Lee Luchford, West Sussex (GB); Adrian Taylor, Cambridge (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LTD., London (UK)

(21) Appl. No.: 11/569,283

(22) PCT Filed: May 18, 2005
(86) PCT No.: PCT/GB2005/001921

§ 371 Date: Dec. 3, 2007

(30) Foreign Application Priority Data
May 20, 2004 (GB) 0411197.7

(51) Int. Cl. G06F 9/44

(52) U.S. Cl. 717/120

(57) ABSTRACT

An incremental release to a body of software is carried out by using automated tools on a computing device. The tools are provided with access to the files comprising a whole body of software to be released, the files comprising the last release of the whole body of software, and also to a component database storing details which include but are not limited to the name, component, and time/date stamp of the files comprising the contents of each one of the components included in the release. The tools are made aware of the set of updated components that need releasing but only release the software after checking that each file in the set of files included in the components that aren't being updated is identical with the same file in the set of files that haven't changed since the last release, that the set of files which are either new or have changed since the last release is identical to the set of files included in the components that are being updated, and also that each of the files comprising the whole body of software to be released is included in exactly one component. The tools also update the component database for each component and each changed file as part of the release of the software.

The present invention relates to a method of operating a computing device, and in particular to a method for operating such a device in a manner which allows a plurality of developers to create and distribute parts or components of a customisable software product, whilst offering relative assurance that a complete and coherent whole of the software product can be assembled from the parts or components.

A customisable software product may be defined as one where recipients receive all or part of the source code used to build the software product along with the corresponding binaries or executables, thereby enabling the recipients to modify the software to their own requirements.

This definition of a customisable software product includes both open source software and free software. It also includes products where the recipients of the source code and the software comprise a restricted group. For example, the Symbian OS operating system developed by Symbian Ltd of London is a customisable software product, since the authorised recipients of the operating system receive all or part of the source code used to build the software along with its binaries or executables, thereby enabling them to modify the software to their own requirements.

When any body of software under continual development is released on a regular basis, there are generally in each release only relatively small changes to certain parts of the software body as a whole; i.e. the bulk of the software body often remains unchanged from one release to the next.

However, in order to ensure consistency and uniformity amongst all recipients of the releases, it is commonplace for the whole body to be completely reconstructed and redistributed in its entirety for each release. This is usually achieved either by copying the installation files to physical media, such as CD-ROM or other non-volatile storage media, or by making the installation files available for download via the Internet or other data transfer medium. All of the original software files are included in the update, even those that have not changed since any previous release of the software. However, for large software bodies, such as computing device operating systems, this can mean the distribution of an unnecessarily large number of CD-ROMs for each release, or if the Internet is used for downloaded distribution, many hours or even days of connection time to download the files.

This method of disseminating changes to the software body is commonly referred to as monolithic distribution. Its key advantage is that because it effectively builds the software in its entirety each time, it provides a common reference platform that is, in essence, guaranteed to work for all recipients, irrespective of how any recipient has modified the previous release. This distribution method is generally regarded as the most common method of releasing updates for any type of software.

An alternative method for the distribution of a release of updated software is for only those parts of the software which are functionally different from the previous version to be distributed, independently of the whole, with the entire body of software then being reconstructed by the recipient as needed. This method of disseminating changes may be referred to as incremental distribution. Its most obvious advantage is that it is quicker and more efficient than monolithic distribution because a smaller amount of data needs to be distributed for each release. Other significant advantages arise from the fact that incremental distribution relies on the division of the whole body of software into independent parts, generally called components, the existence of which enables the recipients to preserve as much as possible of the investment that they may have made in modifying a previous release. Incremental distribution enables this in two ways: firstly, because it distributes precisely what is needed to update the software product and secondly, because recipients may selectively decide to discard any component updates which are not needed for their respective customisation of the software product.

An overview of re-release and distribution of software updates has been compiled by Colin Percival of the Computing Laboratory at Oxford University. This overview can be found at http://www.daemonology.net/freebsd-update/binup.html, and outlines many of the problems and difficulties in this area. However, Percival has not found any methods suitable for use with customisable software products as referred to above. Two superficially similar software update methods that are described in the overview are sufficiently well-known to be worth mentioning in more detail here:
There exist methods of monolithic distribution for partial releases which do not include customisable source code. Specifically, Microsoft update their operating systems and software suites by issuing service packs rather than by reissuing the entire body of software, and these service packs differ from complete reinstallations in that they preserve the customisations of users for the software in question.

However, the release of such service packs does not fall into the problem domain this invention seeks to address because the Microsoft products to which the service packs are applied cannot be regarded as customisable software products. Most importantly, no source code is included in the service packs or is distributed to users. Consequently, users are not able to modify the software source code in order to customise the product to their own requirement; they are only able to customise the behaviour of the product, within the limits permitted by the product designers and authors. In particular, there is no control of the update process when installing a service pack, and users cannot decide upon actual selective adoption of any portion of a service pack.
There also exist methods used by Linux distributions which enable recipients to integrate separate component updates into an operating system. The most well-known of these methods are those based on the Debian package manager (see http://www.debian.org/doc/debian-policy/ch-binary.html for more information on componentisation in Debian Linux) and the RPM system developed by Red Hat and adopted by the Linux Standard Base project (see http://www.rpm.org/ for more information on the RPM Package Manager).

However, such package management systems also do not fall into the problem domain this invention seeks to address. This is because companies such as Red Hat and organisations such as Debian do not themselves produce customisable software products. What they do is to aggregate and integrate independent and separate customisable software products from multiple sources and authors, and package these independently produced components in such a way that recipients can successfully integrate them. There is no need with Linux distributions to offer any guarantees about the relationship between a whole body of software as shipped and the whole body of software that the recipients of their component releases may be using.

There is therefore a clear distinction in the way that components have to be delineated and then managed by operating system authors and distributors who design, write and build their software as an integrated whole, and the way that components are accepted and redistributed by Linux vendors who, for example, assemble an operating system from customisable software products produced by other people and have no need to incrementally update the whole body of the software they ship in a consistent and coherent manner.

It can be appreciated from the above description that the key advantage of a monolithic distribution is that it is, in essence, guaranteed to work for all recipients irrespective of how they have modified the previous release.

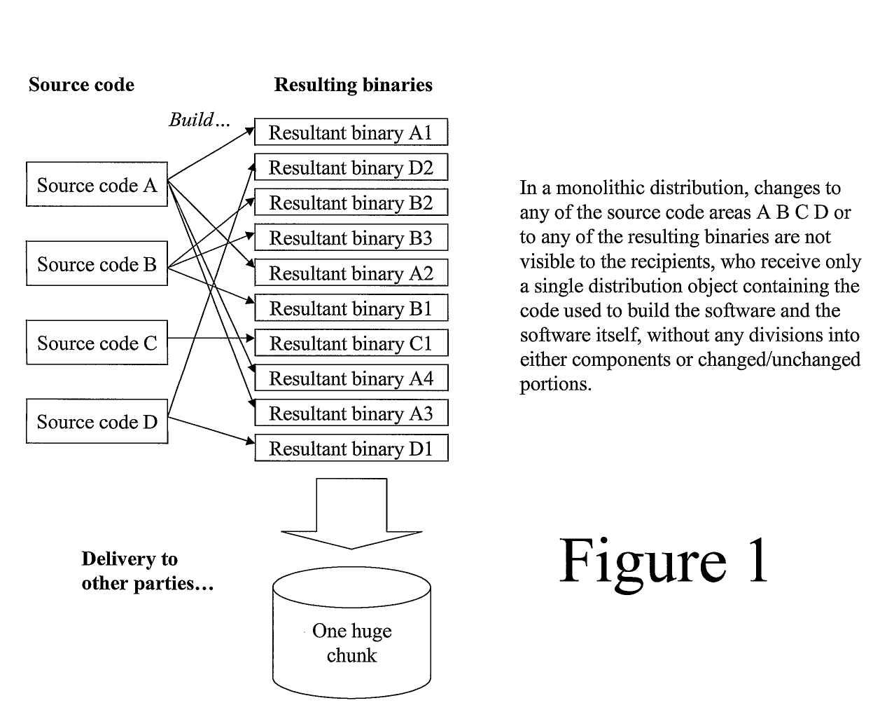

Monolithic distribution is shown diagrammatically in FIG. 1. However, it is an imperfect method for several reasons, including the following:
Distributing both changed and unchanged portions of the software is inefficient, expensive and inconvenient. This is especially true where the changes for a particular release are very small, the quantities of data involved are very large, and the distribution channel is of limited capacity. Customisable software products typically involve large amounts of data because the source code is distributed along with binaries. In the case of an operating system such as the Symbian OS operating system, it could take days for all the data to transfer online over a medium bandwidth data connection.
The requirements of consistency and uniformity imposed by a monolithic distribution policy require that the body of software should be produced according to a standard policy, ideally in one place and at one time by one set of people: in practice this usually represents a considerable development bottleneck.
Because the distribution is not divided into components, and because the changed and unchanged portions of the software are indiscriminately included, there is no easy way for recipients to choose which components of a distribution they want to take; the distribution is not divided into separate components from which recipients can choose. For example, supposing that an update to a particular device driver is all that a particular recipient requires, that recipient would have to attempt to break down the entire distribution and analyse its contents in order to extract just those portions that are needed to build the required device driver. This is of course theoretically possible, since the distribution does include full source code and build information. But, it is likely that the changes in the distribution will be sufficiently complex to make the chances of success in a reasonable timeframe very small. Such a recipient may therefore have to accept all updates contained in the release, whether they are all needed or not.

While incremental distribution overcomes many of the difficulties imposed by monolithic distribution and therefore offers potential benefits in terms of speed and efficiency, it gives rise to its own concerns.

Incremental distribution has in certain respects potentially higher risks than monolithic distribution in that there is more that can go wrong for the software producer, because only partial source code is being distributed. This is especially true for large bodies of software such as operating systems. For example, additional source files (which are new rather than unchanged) may accidentally be omitted from the release. Or, where co-dependencies between components are very complex, failure to release any one component may result in the recipient finding that source code or header file files may exist as multiple versions in the release.

Another source of risk arises from one of the reasons for the attractiveness of incremental distribution for recipients of software, namely that the recipients are able to pick and choose which components they take on the basis of what they actually need and use. Because of this, the authors or distributors will be faced with the near certainty that their product will be used in multiple different configurations by different recipients. The authors or distributors have no way of telling whether any particular module has been updated or customised, and are faced with the prospect of each recipient build in the field having a unique mix of customised components, updated components and original components. This decreases their control of the quality of their product and increases their support costs.

Incremental distribution entails additional risk even when producers make no mistakes in their release process, and even if recipients take every component in the release. Because it does not start from a ‘clean’ base release, the release cannot offer the author or distributor an equivalent level of assurance as can be provided with the monolithic distribution method; that all recipients are building precisely the same version of the software. This is because it is the recipient and not the author or distributor who is responsible for merging the new and old distributions and then rebuilding the body of software for actual use.

Furthermore, the accidental complexities of the build process, and its dependence on specific and largely uncontrollable aspects of the configuration of the local system used for the rebuilding, are such that it is not always possible to guarantee the integrity of the entire body of rebuilt software for any recipient.

Additionally, the division of a body of software into components is essential for incremental distribution: it is not possible to employ this method if the software can only be built monolithically. However, as will be apparent to persons familiar with this art, even with good modular architecture, dividing a large body of software into independently distributable components is not a straightforward operation. Determining the many relationships and interdependencies between different areas and components is a difficult and time-consuming process.

Moreover, the actual task of identifying only those parts of the software that need to be included in an incremental distribution is non-trivial. It is regarded as a high risk procedure to try and optimise this manually. Colin Percival of the Computing Laboratory at Oxford University points out in relation to manual efforts that “they all attempt to minimise the number of files updated, and they all include human participation in this effort. This raises a significant danger of error; even under the best of conditions, humans make mistakes, and the task of determining which files out of a given list had been affected by a given source code patch requires detailed knowledge of how the files are built.”

In relation to this last point, it should be noted that while manual optimisation may be risky, automatic optimisation of a release is also not easy to implement. This is because it can be quite difficult to automatically distinguish between functional and non-functional changes. An example of a nonfunctional change in a file is where spelling mistakes in the comments attached to source code have been corrected. Such a correction clearly changes the contents of the source code, but in a non-functional way. When the source code is recompiled, this will change the timestamps contained in an associated object file, again in a non-functional way. The use of automated software tools which automatically check files for differences (such as ‘Diff’ and methods such as providing digests of files in order to uncover changed components, will all flag both the source code and the object file as altered. The consequent failure to optimise incremental distribution results in the distribution of items that do not need to be updated.

However, there is some prior art teaching on how to minimise this effect. For example, Percival describes one method for avoiding the re-release of binary files simply because the internal timestamp has changed by building the file from the same source twice but with a different system date each time, and then doing a byte-for-byte comparison to discover the place where the datestamp is stored. This makes it possible to exclude such areas of files when comparing past and present releases, and therefore avoid false positives when identifying changed components. Symbian Ltd has also previously published as part of the Symbian OS operating system a tool called ‘evalid’, which does a byte-for-byte comparison of files but ignores these unimportant differences. However, it should be noted that all these solutions to the problem of identifying those parts that need to be included in an update still rely on file comparisons to function.

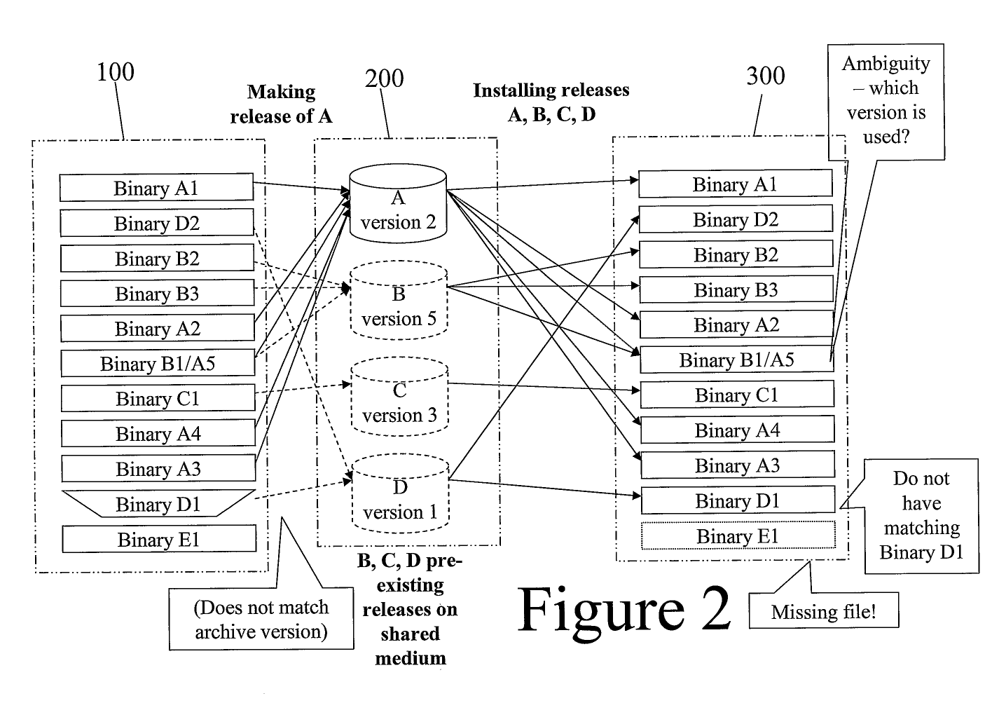

Some of the end results arising from the inherent problems of incremental distribution are shown diagrammatically in FIG. 2. Three of the risks can be clearly seen by comparing this incremental distribution model with the more simplistic monolithic model shown in FIG. 1. The left-hand portion 100 of FIG. 2 shows binary files built by the software producer, the middle portion 200 of FIG. 2 shows the components that were released, and the right-hand portion 300 of FIG. 2 shows the files that the recipient ends up with. Altered binary files are indicated by dotted lines linking them to the components to which they belong. It can be seen that a failure to re-release component A results in binary file B1/A5 existing in two incompatible versions; binary file E1 not being included in the release at all; and binary D1 used in the component build not matching the version that was received.

It is clear from the above discussion that there is no available method of reconciling the advantages of the monolithic distribution method with the advantages of the incremental distribution method.

Accordingly, it is an object of the present invention to provide an incremental distribution method which can provide a level of assurance equal to that of the monolithic distribution method so as to ensure that a set of component releases can completely and accurately represent a whole body of software.

The invention further includes an optimisation of the incremental distribution method enabling authors, distributors and recipients to distinguish between functional and non-functional changes, which ensures that no unnecessary content is distributed in a release, thus maximising both efficiency and convenience.

According to a first aspect of the present invention there is provided a method

According to a second aspect of the present invention there is provided a computing device arranged to operate in accordance with a method according to the first aspect.

According to a third aspect of the present invention there is provided computer software for causing a computing device according to the second aspect to operate in accordance with the method of the first aspect.

An embodiment of the present invention will now be described, by way of further example only, with reference to the accompanying drawings, in which:—

FIG. 1 illustrates diagrammatically a monolithic method for the distribution of a body of software;

FIG. 2 illustrates diagrammatically an incremental method for the distribution of a body of software;

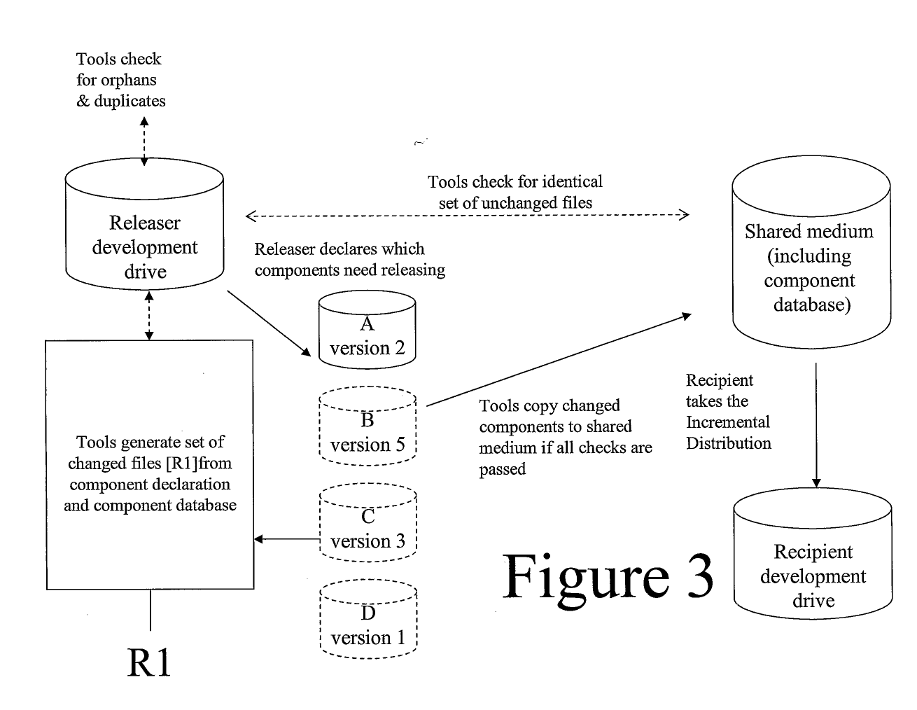

FIG. 3 illustrates diagrammatically how component releases for a body of software may be arranged between a releaser and a recipient of the body of software; and

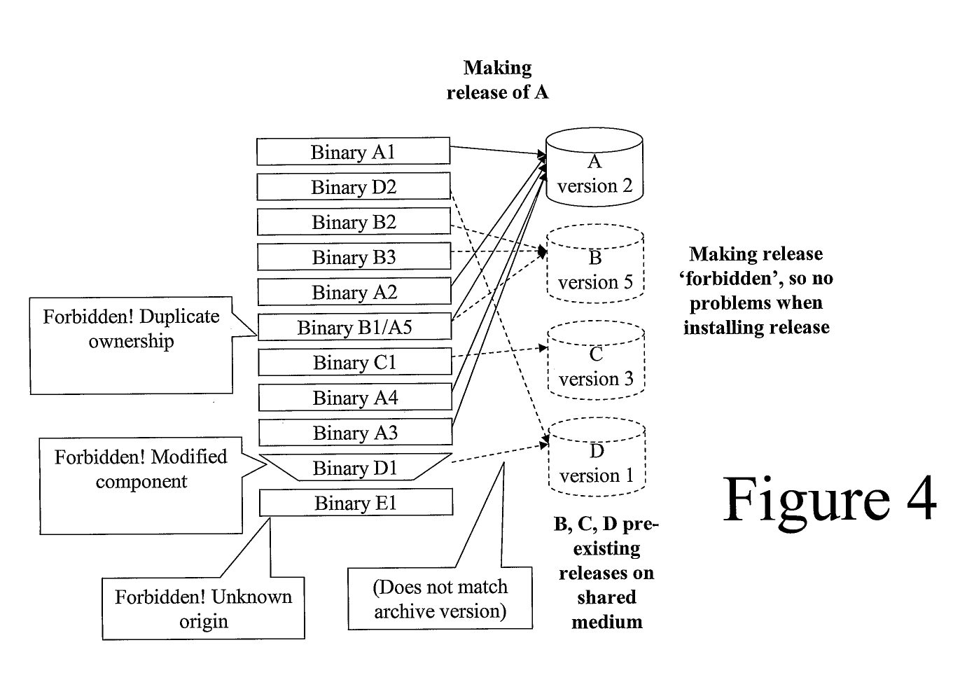

FIG. 4 illustrates diagrammatically how a check may be made for each file on a release development drive to see if it is either identical to the file in the same component on a medium to be shared with a recipient of a body of software.

In the embodiment of the present invention described below, the component releases are made, and the relative guarantees are enforced, by a set of automated tools. The following assumptions are made for the purposes of this embodiment of the invention:
Component releases are made by a person or a team of people referred to herein as the releaser and it is assumed that the releaser has its own copy of the body of software on its own development drive.
Component releases are delivered to a person or team of people referred to herein as the recipient and it is assumed that the recipient has its own copy of the body of software on its own development drive.
It is assumed that software is made available by the releaser to the recipient via a shared medium such as a computer network, an FTP (file transfer protocol) site, or even a CD ROM.
It is assumed that the software has been divided into components, and that some kind of component database or equivalent data store exists listing these components, the dependencies between them, the source files required to build them, and the binary files that they produce. Copies of this database may optionally be maintained on the shared medium for convenience since this enables recipients to copy the relevant portions of this database to their local development drive for each component updated.
It is assumed that at the start of the release process the contents of the recipient development drive, in relation to the body of software, is identical to that of the shared release drive (the recipient has the latest release of the software) and that the content of the releaser developer drive is not the same as that of the shared release drive (the latest release of the software is not the current version and a new release needs to be made).

These relationships are shown in FIG. 3. The process used can be summarised as follows:
a) The releaser informs the release tools by some appropriate means of those components of the software body which have changed and of those components which have not changed. The files included in all these changed components comprise the set of changed files shown as R1 in FIG. 3. It is considered that those skilled in this art will be aware that there are many possible ways of passing this information, such as by passing on a command the name of a file or files where the information can be found; the exact method used to achieve this information transfer is not considered material to the working of this invention. Accordingly, the present invention can be adapted to function with any of them.
b) The releaser then issues a command to the tools telling them to make new releases of the components that are now known by the tools to have been changed. The consistency and completeness of the release may be checked by the tools during this part of the process as follows:
   i) As shown in FIG. 4, a check is made for each file on the release development drive to see if it is either identical to the file in the same component on the shared medium, or, if it is either not identical or not present on the shared medium, to see if it is listed as a file belonging to the set of changed components (R1 in FIG. 3). The release fails if any of these checks fail.
   ii) Also as shown in FIG. 3, the software on the releaser development drive is checked to ensure that each file is included only in precisely one component; that no file is omitted in any component; and that no file is included in more than one component. The release fails if this check fails.
c) Finally, the tools release the latest version of the software by copying the set of changed files (R1 in FIG. 3) from the releaser development drive on to the shared medium.
d) As well as the actual files included in the release, the tools also generate and release metadata consisting of details of those components of the software body that have been changed; this is done by updating the component database with information based on a valid declaration of changed components made by the releaser at the start of the process. This metadata is used by recipients to extract the incremental update from the shared medium, as described below.

Note that in a preferred implementation of this invention used by Symbian Ltd the release metadata also contains a list of the other components present in the development environment when the release was made. This ‘environment’ information, combined with the enforced constraints, enables the precise environment of any release to be recreated on another computer, based solely on the newly made releases, plus previously made releases.

The following pseudocode describes the releasing process more precisely:

### Releaser Pseudocode

1 Releaser declares that certain of the installed components are ‘pending release’ with the declaration for each component including either a manifest of all the information comprising that component or else the information needed to obtain such a manifest via the tools used to build that component
2 Releaser requests tools to make these component releases
3 Make list of files on Releaser Development drive—call it ‘unknown origins’ list
4 Start with empty list of ‘owned files’
5 Examine ‘component database’ to see what is installed
6 Foreach (installed component)
7 Set component status to clean
8 Is component ‘pending release’?
9 If no:
10 Set component status to ‘clean’
11 Examine the originally-installed version of component, which is still on the shared medium used for releases; get list of files that were included
12 If yes:
13. Obtain list of files belonging to component, from releaser declaration
14 Foreach (file belonging to that component)
15 Remove file from list of ‘unknown origins’
16 Is file in list of ‘owned files’?
17 If yes:
18 Abandon release (duplicate ownership)
19 If no:
20 Add file to list of ‘owned files’
21 Is file on the Releaser development drive?
22 If no:
23 Abandon release (missing files)
24 Is component ‘pending release’?
25 If no:
26 Does file match the version that was originally installed?
27 If no:
28 Abandon release (dirty components)
29 Next (file belonging to that component)
30 Next (installed component)
31 Are there any ‘unknown origin’ files left?
32 If yes:
33 Abandon release (unknown origin files)
34 Foreach (pending release component)
35 Create archive of release, for use by others
36 Record up-to-date filenames and timestamps in component database
37 Next (pending release component)
38 Record with the release, the list of all components in ‘component database’

Whenever the release is abandoned in the above algorithm the releaser needs to fix the concern which caused the abandonment before making another attempt. An optimisation would be for the process to continue checking for further errors instead of abandoning, but not to make any releases, in the same manner that code compilers carry on compiling when they encounter errors rather then stopping on the first one they find. This would allow the releaser to reduce the number of iterations for each release.

Once the release has been made, the recipient then obtains and installs the new release from the shared medium using a complementary set of tools. The key point of this embodiment is that the releases must have been made using the above algorithm; this guarantees that there is no possibility of gaps, no overlap, and that no components will be irreproducible from releases on the shared medium. The algorithm in the following pseudocode assumes that the recipient already has a previous release and simply requires the updated components since that release.

### Recipient Pseudocode (1)

1 Recipient requests the changed entries in component database since the last release taken
2 Foreach (changed component release in database)
3 Extract latest files of release onto recipient development drive
4 Update recipient copy of the component database to record the component version installed
5 Next (changed component release in database)

This algorithm functions even if the recipient has skipped releases. It also functions for recipients who have not taken any previous releases and for recipients desirous of obtaining a ‘clean’ release, provided that in such a case all components would be marked as changed.

There is in a preferred implementation of the invention an optimisation in the releaser pseudocode algorithm at line 26. This step represents where the present invention checks, for each file which is to remain unchanged, that the version on the releaser developer drive is identical to the version on the shared medium.

The basis of this optimisation is that the data in a file can be mathematically manipulated to produce a single number that represents the contents of that file, variously termed a message digest, a hash or a checksum. Depending on the algorithm used to compute this number, it is exceedingly unlikely that two files will have the same message digest. Hence, it is possible to compare the digests for two files instead of comparing the files themselves in order to verify identity. A number of suitable algorithms exist in the public domain, such as the well-known MD5 algorithm. It is common practice to distribute such digests along with files to enable recipients to verify identity.

Therefore, in a preferred optimisation of the invention, it is proposed to include in the information contained in the component database on the shared medium a digest of the significant portions of each file included in that component, to calculate a similar digest for each file to remain unchanged, and to match these two digests against each other to verify identity. Such a distribution of a digest not of the whole file but only of the significant portions of a file is another advantageous aspect of this invention. It will be appreciated that a digest-to-digest comparison is a quicker and more efficient method than a file-to-file comparison, and does not require access to any file apart from the file being checked in order to function properly. In a preferred implementation, the method is as follows:
First, the file is examined to determine its format. This can often be achieved simply by reading the first few bytes. The file format specifies the structure of the remainder of the file, which is then examined to determine what parts are deemed ‘important’ and what parts are deemed ‘unimportant’.
The rules for deciding what is ‘important’ depend on the precise aims of the operation. The simplest case for binary files is to ignore those parts that are changed simply be re-creating the file (such as timestamps) since only those parts that represent the function of the file (such as computer machine code) are considered of interest, and therefore to be important. The simplest case for source files is to ignore all comment and whitespace in the file. The precise method of deciding on which portions are important is not a part of this invention; however it works, for example, with the algorithm proposed by Percival for discovering timestamp locations in binary files.

A number of different mechanisms for propagating the data identifying each file format and the rules for deciding the important area to all the recipients are possible, such as incorporating the format descriptions in the tools or alternatively storing them on the shared medium in tool-readable form.
Once the important areas have been identified, the simplest approach is to copy the original file to another ‘virtual’ file. The unimportant areas are omitted from this virtual file. The message digesting process is then applied to this virtual file to produce a digest that represents only the important functional areas of the file. Thus, the digests will be identical between two files that have the same function (i.e. important data) but different ‘unimportant’ data.
Various shortcuts are possible; for example, it is possible to run the digest routine over selected parts of the original file without making a copy. Similarly, there may be existing readily-available transformations to produce a representation of just the important parts of a file (for example disassembling an executable file). These may be used to save implementation complexity, and also execution time.

As well as enabling releasers to efficiently identify changed files, this optimisation also allows recipients to check the integrity of their version of the body of software; they can simply compute message digests of the significant portions of files and then check that each digest matches the one stored for the same file in the same release in the component database. One possible algorithm for achieving this is as follows:

### Recipient Check Software Body

1 Recipient requests all the entries in component database for the release to be checked
2 Foreach (component)
3 Foreach (file in component)
4 Compute message digest of significant sections of file as stored on recipient developer drive
5 Check that the digest matches the one stored in the component database for the same version of the same file
6 If no:
7 Report software may be compromised
8 Next (file in component)
9 Next (component)

The present invention is considered to provide the following exemplary significant advantages over the known methods for distributing a body of software
It offers a way of assembling a guaranteed and coherent whole body of software out of a set of independent components—the lack of the mechanisms described above make componentised distribution a considerable risk, which is why many recipients are currently unwilling to adopt componentised files and will only adopt the entire body of software each time.
It lends itself to distributed releasing; there is no need to waste time and money distributing huge volumes of data produced in a single place by centralised build and integration teams. With these virtually guaranteed component sets, parts of the whole body of software can be produced in different places at different times and still offer recipients clear guarantees that the result is complete and consistent.
The additional flexibility in shipping embedded software to multiple recipients significantly reduces the time required to develop products reliant on the software—the development of a variety of different models of mobile phones using a common but customised operating system is a good example of this.
The use of relatively small message digests of significant portions of files, which can be easily stored and readily used to verify functional identity, makes it quick and easy for releasers and recipients to detect when files and components really have changed. Especially for large software products such as operating systems, this can make a difference of an order of magnitude in the cost and time of distributing, taking and verifying new releases.
The method can be applied to any body of digital or numerical data, and not just computer software files.

Although the present invention has been described with reference to particular embodiments, it will be appreciated that modifications may be effected whilst remaining within the scope of the present invention as defined by the appended claims.

1) A method of operating a computing device using automated tools for releasing an update to a body of data comprising a plurality of components, the method comprising:
enabling access to files comprising the body of data to be released;
enabling access to files comprising the last release of the body of data;
advising a set of updated components to be released;
enabling access to a component database comprising the name, component, and time/date stamp of the files for each component of the update;
checking that the files included in those components not being updated are identical with the corresponding files in the last release of the body of data;
checking that the files which are new or changed since the last release are identical to the corresponding files of the components being released;
checking that each of the files to be released is included in only a single component; and
updating the component database.

2) A method according to claim 1 wherein:
the tools are arranged to have access to the files comprising the whole body of data that has been released; and
the tools are arranged to interrogate the component database and only take those components of the release that have changed since the last release of the data.

3) A method according to claim 1 wherein:
the component database for each file in the body of data includes a message digest of only the functionally significant portions of the file;
the step of updating the component database includes calculating and storing a new message digest of only the functionally significant portions of each changed file; and
the step of checking that the each file included in the components that are not being updated is identical with the same file in the previous release is performed by calculating a message digest of only the functionally significant portions of the file and checking that it is identical to a digest for that previous release of that file stored in the component database.

4) A method according to claim 3 comprising verifying the integrity of the release of the body of data by calculating message digests of only those functionally significant portions of each of the files and checking that these message digests are identical with the message digests for each file in the component database.

5) A method according to claim 1 comprising copying, storing or updating information relating to the body of data on to a shared access medium such as a networked computer disk and the method of obtaining a release or an update to a release is by copying, storing or updating information taken from the shared access medium.

6) A method according to claim 1 comprising copying, storing or updating information relating to the body of data on to a distributed medium such as a computer tape or compact disk or digital video disk and the method of obtaining a release or an update to a release is by copying, storing or updating information taken from the distributed medium.

7) A method according to claim 1 wherein all or part of the steps are carried out by operating the computing device in a debug mode for simulating what would happen without either releasing or obtaining any data.

8) A method according to claim 1 wherein the body of data comprises an operating system for a computing and/or telecommunications device.

9) A method according to claim 1 wherein the body of data comprises a body of digital or numerical information.

10) A computing device arranged to operate in accordance with a method as defined in claim 1.

11) Computer software arranged to cause a computing device to operate in accordance with a method as claimed in claim 1.
